(19) United States
(12) Patent Application Publication
(10) Pub. No.: US 2011/0184931 A1
(43) Pub. Date: Jul. 28, 2011

(54) List based attribute web search

(75) Inventor: Sitaramarao Srinivas Yechuri, Dwarka (IN)

(73) Assignee: Sitaramarao Srinivas Yechuri, Dwarka (IN)

(21) Appl. No.: 12/987,140

(22) Filed: Jan. 9, 2011

Related U.S. Application Data
(60) Provisional application No. 61/336,426, filed on Jan. 22, 2010.

(51) Int. Cl. G06F 17/30

(52) U.S. Cl. 707/710; 707/E17.108

(57) ABSTRACT

If you know the name of a film star or a sports person then it is easy to find information about them. But suppose you don't know the name of the person you are trying to find. Suppose all that you know is that he is a singer who is homosexual and was knighted. My invention is a web search engine and you can submit a query to it such as: Occupation=“Singer”, Sex=“Male”, Sexuality=“Homosexual” and Honors=“Knighted”.

In my invention I maintain a database of people, entities, things, places i.e. any proper noun. Each proper noun has a list of attributes such as Sex, Occupation, Education and hundreds of other attributes. This database is fed by many sources such as parsing web pages obtained by a web crawler, a human being entering the data manually, loading names from a telephone book, reading from the social security database etc. The database can be searched by the public and maintained by contributions or advertising revenue.

The web search page can also serve as a gateway to other web search engines, i.e. the user can click on the search results and this will cause a new tab to be created wherein a query constructed by this invention is submitted to another web search engine. So for example, if the occupation in the search is listed as actor, a query to display the movies he/she acted in could be generated.

### CROSS-REFERENCE TO RELATED APPLICATIONS

This Utility patent application is based on Provisional Patent Application No. 61/336,426, filed on 22 Jan. 2010.

### BACKGROUND OF THE INVENTION

There are many websites that can tell you everything you wish to know about people, places, things and entities but what if you don't know what the person, place or thing is called? Most people search on the web hoping to find clues from different web pages from different sites. But this invention will find the name of any person, place or thing if you know some of it's attributes.

### BRIEF SUMMARY OF THE INVENTION

If you know the name of a film star or a sports person then it is easy to find information about them. But suppose you don't know the name of the person you are trying to find. Suppose all that you know is that he is a singer who is homosexual and was knighted. My invention is a web search engine and you can submit a query to it such as: Occupation=“Singer”, Sex=“Male”, Sexuality=“Homosexual” and Honors=“Knighted”.

In my invention I maintain a database of people, entities, things, places i.e. any proper noun. Each proper noun has a list of attributes such as Sex, Occupation, Education and hundreds of other attributes. This database is fed by many sources such as parsing web pages obtained by a web crawler, a human being entering the data manually, loading names from a telephone book, reading from the social security database etc. The database can be searched by the public and maintained by contributions or advertising revenue.

The web search page can also serve as a gateway to other web search engines, i.e. the user can click on the search results and this will cause a new tab to be created wherein a query constructed by this invention is submitted to another web search engine. So for example, if the occupation in the search is listed as actor, a query to display the movies he/she acted in could be generated.

### BRIEF DESCRIPTION OF THE SEVERAL VIEWS OF THE DRAWING

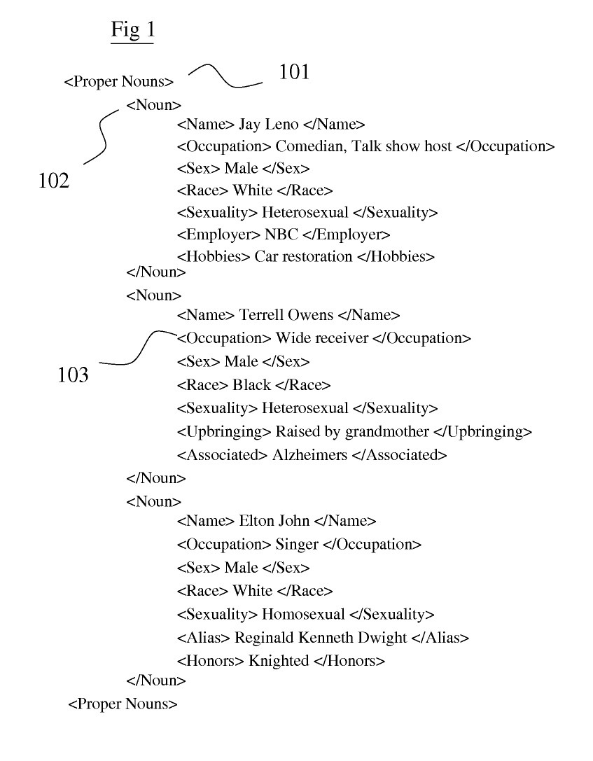

The XML code in the figure FIG. 1 shows a text implementation of the database of proper nouns. 101 is the database of proper nouns. 102 is an entry in the database. 103 is an attribute of the entry in the database. Each entry has a mandatory attribute of “Name” which contains the proper noun. All other attributes are optional. For the entry with Name=“Elton John”, Occupation=“Singer”, Sex=“Male”, Race=“White”, Sexuality=“Homosexual”, Alias=“Reginald Kenneth Dwight” and Honors=“Knighted”.

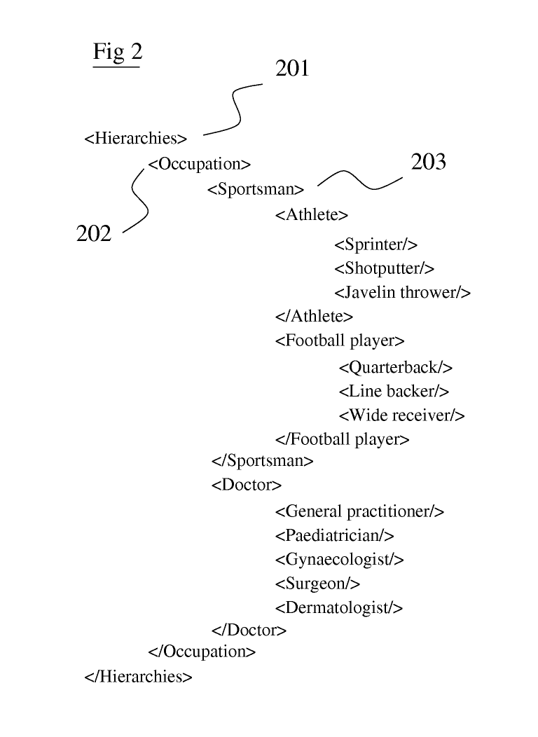

The XML code in the figure FIG. 2 shows a text implementation of the database of hierarchies. 201 is the database of hierarchies. 202 is an entry in the database and refers to the attribute type “Occupation”. Two types of occupations are shown in the figure FIG. 2, namely “Sportsman” and “Doctor”. The occupation “Sportsman” is marked as 203. The occupation of “Sportsman” has two sub-classes shown of “Athlete” and “Football player”. “Quarterback”, “Line backer” and “Wide receiver” are different types of “Football player”. So if a person has the occupation of “Quarterback” it also means that the person has occupation of “Football player”. Similarly there are five types of “Doctor” shown in the figure FIG. 2 namely, “General practitioner”, “Pediatrician”, “Gynecologist”, “Surgeon” and “Dermatologist”. So if a person has the occupation of “Dermatologist” it also means that the person has occupation of “Doctor”.

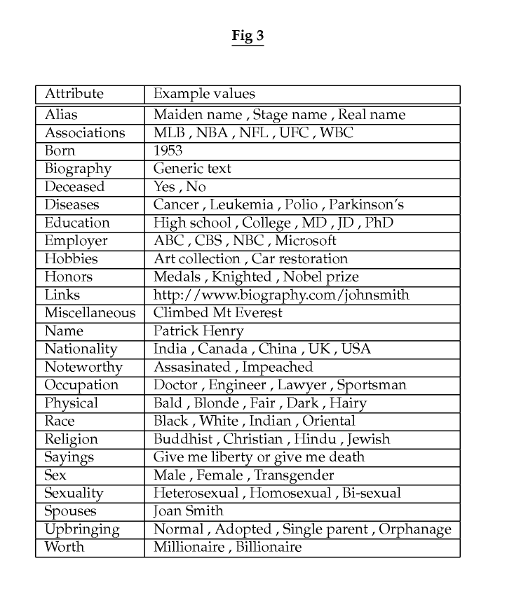

The table in the figure FIG. 3 shows the common attributes for a person. Although different people have different life histories and personalities, their attributes can be tabulated and selected from a common list of values. The table in the figure FIG. 3 shows example values for these attributes.

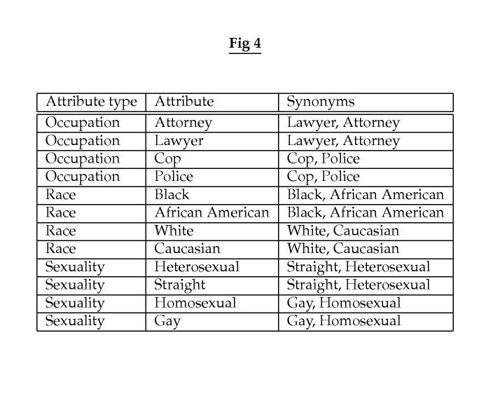

The table in the figure FIG. 4 shows commonly used synonyms. Some words have multiple meanings based on the context. For example as shown in the figure FIG. 4 if the Race is specified as “White” then the search must also include Race=“Caucasian”.

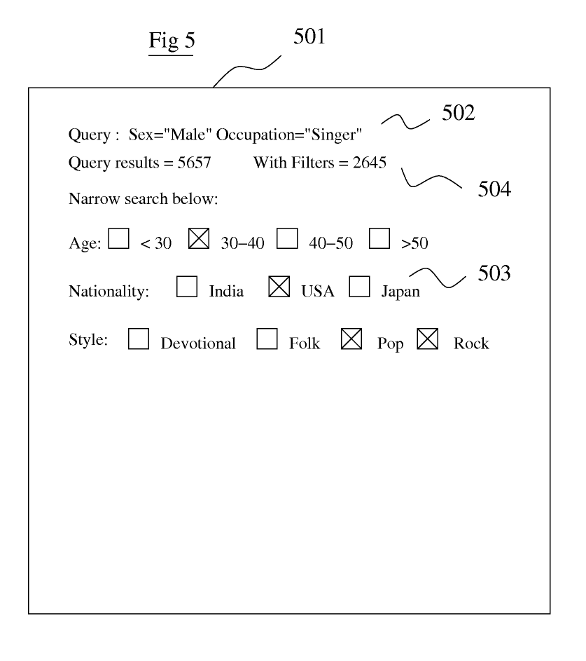

The figure FIG. 5 shows the results as displayed when the number of search results is very large. 501 is the web page. 502 is the query as it was submitted. In the figure FIG. 5 the number of results is shown as 5657. Since this is very large, the user is presented an opportunity to narrow the results with choices. 503 is a choice to narrow the choice by nationality of the singer and as can be seen the nationality of USA is chosen. Based on the selected attributes the number of search results is reduced to 2645 as shown in 504.

### DETAILED DESCRIPTION OF THE INVENTION

This invention finds names of people, places, things, entities, chemicals i.e. any proper noun. Every person has attributes that are cataloged in the database of proper nouns shown in the figure FIG. 1. The person who uses this search engine does not know the proper noun but rather a few of it's attributes. Sometimes the user may know a portion of the name, but is not sure how it is spelled. For example Name=“Kiss*” will find the name “Kissinger”.

This invention handles hierarchies as shown in the figure FIG. 2. When a user searches for Occupation=“Football player”, the search will include all the occupations listed under “Football player” in the figure FIG. 2 namely, “Quarterback”, “Line backer” and “Wide receiver” as well. So any entry in the proper noun database in the figure FIG. 1 with occupation of “Wide receiver” will show up in the search results even though the user did not explicitly search for the Occupation=“Wide receiver”. This is because when the user searches for Occupation=“Football player”, the search algorithm looks up the figure FIG. 2 and expands the search with the Occupation=“Quarterback”, the Occupation=“Line backer” and the Occupation=“Wide receiver”.

An example of some of the attributes which can be specified for a person is shown in the FIG. FIG. 3. Here the attributes shown include “Alias”, “Associations”, “Born”, “Biography”, “Deceased”, “Diseases”, “Education”, “Employer”, “Hobbies”, “Honors”, “Links”, “Miscellaneous”, “Name”, “Nationality”, “Noteworthy”, “Occupation”, “Physical”, “Race”, “Religion”, “Sayings”, “Sex”, “Sexuality”, “Spouses”, “Upbringing” and “Worth” along with sample values for each attribute.

Similarly this invention considers synonyms as well. For example when a user searches for Race=“Black”, any entry in the proper noun database in the figure FIG. 1 with Race=“African American” will show up in the search results even though the user did not explicitly search for the Race=“African American”. This is because when the user searches for Race=“Black” the search algorithm looks up the figure FIG. 4 and expands the search with Race=“African American”.

Any attribute can be searched for. So if the search specifies Honors=“Purple Heart” only people who won the “Purple Heart” are listed in the search results. If the person you are searching for said something inspirational you could search Sayings=“Give me liberty” and it would give you the search result of Patrick Henry. You can even search the field Biography except it would slow down the search.

Once the search is executed, the number of results obtained determines how the results are displayed. If the number of search results is small the proper nouns can be displayed along with some of the attributes for each proper noun. However if the number of results is very large i.e. perhaps 50 pages worth, then the user is given information on how to narrow the search by adding attributes. For this purpose the distribution of the number of results by attribute can be displayed. For example if the distribution of results by Nationality is displayed along with a pull down menu to allow the user to select a Nationality, then as the user selects a Nationality, the results for that Nationality is displayed. A sample page showing how to limit the number of search results is shown in the figure FIG. 5. As each attribute is selected the number of search results is updated.

1. A method of finding the name of a famous person comprising the steps of:
making a set L of possible attributes that any famous person may have;
creating a set R of relationships between the attributes in the set L;
loading the names of all famous people into a database D along with their associated attributes;
displaying a generic set K of attributes for the user to select from;
allowing the user to select a set P of attributes from the set K;
based on the set P, iteratively displaying a new set K of related attributes from the set L, by the use of the relationships in the set R and allowing the user to refine the set P of attributes about the person the user is trying to find;
searching the database D for people whose attributes either match the set P or whose attributes bear the required relationship to the set P;
displaying the search results.

2. The method of claim 1, wherein the attribute is a text field and the user provides a regular expression to match the text field.

3. The method of claim 1, wherein the relationship is that of a synonym whereby if an attribute is selected by the user, all it's synonyms from the set L based on the set R are automatically selected as an allowed match as well.

4. The method of claim 1, wherein the relationship is that of “is a” whereby if an attribute B is selected by the user, all attributes from the set L bearing an “is a” relationship to B based on the set R of relationships are automatically selected as an allowed match as well.

5. The method of claim 4, wherein the process is iterative, meaning if attribute A has an “is a” relationship to attribute B and in turn B has an “is a” relationship to attribute C, then the selection of attribute C by the user automatically selects attributes A and B as an allowed match as well.

6. The method of claim 1, wherein the relationship is that of “is in” whereby if an attribute B is selected by the user, all attributes from the set L bearing an “is in” relationship to B based on the set R of relationships are automatically selected as an allowed match as well.

7. The method of claim 6, wherein the process is iterative, meaning if attribute A has an “is in” relationship to attribute B and in turn B has an “is in” relationship to attribute C, then the selection of attribute C by the user automatically selects attributes A and B as an allowed match as well.

8. The method of claim 1, wherein the relationship is that of “is a subset of” whereby if an attribute B is selected by the user, all attributes from the set L bearing an “is a subset of” relationship to B based on the set R of relationships are automatically selected as an allowed match as well.

9. The method of claim 8, wherein the process is iterative, meaning if attribute A has an “is a subset of” relationship to attribute B and in turn B has an “is a subset of” relationship to attribute C, then the selection of attribute C by the user automatically selects attributes A and B as an allowed match as well.
